(19) United States
(12) Patent Application Publication
(10) Pub. No.: US 2023/0188047 A1
(43) Pub. Date: Jun. 15, 2023

(54) POWER CONVERTER CIRCUIT

(71) Applicant: SIGNIFY HOLDING B.V., EINDHOVEN (NL)

(72) Inventor: REINHOLD ELFERICH, AACHEN (DE)

(21) Appl. No.: 17/920,874

(22) PCT Filed: Apr. 28, 2021
(86) PCT No.: PCT/EP2021/061121

§ 371 Date: Oct. 24, 2022

(30) Foreign Application Priority Data
May 7, 2020 (EP) 20173479.5

(51) Int. Cl. H02M 3/335; H02M 1/08; H02M 1/44; H02M 7/5388; H02M 1/00; H02M 3/00; H05B 45/37

(52) U.S. Cl. CPC H02M 3/33573; H02M 1/083; H02M 1/44; H02M 7/5388; H02M 1/0058; H02M 3/01; H05B 45/37

(57) ABSTRACT

A power converter circuit (300) comprising: a full bridge inverter and an resonance circuit and a control circuit. The full bridge comprises a first leg (HBx) and a second leg (HBy), each leg having two switches and a switching node between the switches, the switches of the first leg being different from those of the second leg. The resonance circuit is connected between said switching nodes, and comprises an inductance (Lp) in series 5 with a capacitance (Cr). The control circuit generates control signals for the switches in accordance with a predefined scheme having two energizing phases (φ1, φ3) and two passive conducting phases (φ2, φ4) with a configurable duty cycle (DC1, DC2) for achieving zero-voltage-switching (ZVS).

### FIELD OF THE INVENTION

The present invention generally relates to the field of power converter circuits, and more particularly to a power converter circuits comprising an LLC resonant circuit.

### BACKGROUND OF THE INVENTION

Power converters, and more in particular, DC-DC converters are known in the art. Simply stated, they are capable of converting electrical power provided at an input voltage, into electrical power at an output voltage different from the input voltage. By adding a rectifier in front of a DC-DC converter, an AC-DC converter is obtained. A large variety of power converters exist, because many trade-offs can be made, some of which are: input voltage level, output voltage level, ripple on the output voltage, power efficiency, compactness, amount of electromagnetic interference, amount of power to be converted, etc.

The present invention is related to power converters for converting power from a relatively large input voltage range, such as e.g. about 108 Vac to about 305 Vac, to a predefined load or to a predefined voltage.

### SUMMARY OF THE INVENTION

It is an object of embodiments of the present invention to provide a power converter circuit capable of converting power from a relatively large input voltage range to a relatively narrow output voltage range, e.g. for powering an electrical load, e.g. a lighting device from various mains supplies in different countries.

It is an object of embodiments of the present invention to provide a power converter circuit capable of converting an alternating (AC) supply voltage ranging from about 108 Vac to about 305 Vac, at a frequency from about 50 Hz to about 60 Hz, to a predefined DC output voltage, for example about 75 V.

It is an object of embodiments of the present invention to provide such a power converter circuit, having an improved power efficiency, and/or a reduced EMI.

It is also an object of embodiments of the present invention to provide a power converter circuit capable of converting power from a relatively narrow input voltage range to a relatively wide output voltage range, for example from about (220 Vac±5%) at about 50 Hz to a predefined voltage in the range from about 50 V to about 100 V, or from about (110 Vac±5%) at about 60 Hz to about 50 V to about 100 V.

According to a first aspect, the present invention provides a power converter for converting an input voltage into an output voltage, the power converter comprising: a full bridge inverter comprising a first leg and a second leg, the first leg comprising a first high-side switch and a first low-side switch connected in series, and defining a first switch node between them; the second leg comprising a second high-side switch and a second low-side switch connected in series, and defining a second switch node between them; wherein the switches of the first leg have a first output capacitance, and the switches of the second leg have a second output capacitance; a resonance circuit connected between said first switch node and said second switch node, and comprising an inductance in series with a capacitance; a control circuit configured for generating a set of control signals in accordance with a predefined scheme, and for providing these control signals to said switches; wherein the predefined scheme comprises two energizing phases wherein the input voltage is alternatingly applied over the first and second switch node; wherein the second output capacitance is smaller than the first output capacitance; wherein the predefined scheme (under certain conditions) furthermore comprises two passive conducting phases interleaved with the two energizing phases; and wherein the control signals in the passive conducting phases are chosen for facilitating zero-voltage-switching condition of the switches of the first leg during at least some phase transitions.

It is an advantage of using different types of switches (namely first switches having an output capacitance which is higher than that of the second switches), because this can lead to lower circuit losses. More specifically, the first switches (having a higher output capacitance) have a reduced internal resistance (known as “RDSon”), resulting in lower conducting losses, the second switches (having a lower output capacitance) have reduced switching losses. Thus the total losses (sum of the switching losses and the conducting losses) of the power converter can be decreased.

During the energizing phases, the four switches are configured such that a conductive path is created through a high side switch of one branch (or leg) and a low-side-switch of the other branch (or leg). In this way, the input voltage Vin can be alternatingly applied to the nodes X, Y. Or stated in other words, during the first and second energizing phase, the voltage “+Vin” and “−Vin” are applied to the resonant circuit, respectively.

During the passive conducting phases, the switching nodes (X, Y) are either both connected to ground or both connected to the input voltage, thus forming a low-resistance path for the resonance circuit for a configurable time. It is an advantage of using these passive conducting phases because they allow to bring one of the switching nodes (X or Y) to the correct voltage level before some of the switches are subsequently opened or closed at the start of the next energizing phase. This pre-charging thus allows for “zero-voltage switching” of at least some of the switches, which in turn leads to less “ringing” of the signal (lower emi emission) and lower switching losses (higher energy efficiency).

It is a further advantage of using a passive conducting phase between two energizing phases, because its duty cycle (DC2) or relative duration (relative to the period of the control scheme), also referred to herein as “phase”, (PS) is configurable. This offers a further degree of freedom to control the output power.

It is an advantage of this power converter that it has an improved power efficiency (reduced power-losses), without requiring additional hardware components, since the four switches and the controller are already present.

In an embodiment, the switches are MOSFETs or GaN HEMTs.

In an embodiment, a ratio of the second output capacitance and the first output capacitance is a value in the range from ¼ to ¾, or from ⅓ to ⅔.

In an embodiment, a ratio of the second output capacitance and the first output capacitance is equal to about 0.5.

In an embodiment, the control circuit is further configured for measuring one or both of the input voltage and the output voltage; and the control circuit is further configured for using a predefined switching frequency or for using a dynamic switching frequency, wherein the dynamic switching frequency is based on one or both of the measured input voltage and the measured output voltage; and the switches of the first leg and the switches of the second leg are switched at the predefined or the dynamic switching frequency.

In an embodiment, each of the energizing phases has a first duty cycle; and each of the passive conducting phases has a second duty cycle; and the control circuit is configured for determining the first and the second duty cycle as a function of one or more of the input voltage, the output voltage, and the switching frequency.

An example of such a scheme is shown in FIG. 5, and an example of such a function is shown in FIG. 7.

It is an advantage that the first and second time duration can be dynamically adjusted based on the input voltage, because this facilitates lossless switching or quasi lossless switching by using a phase shift operation.

In an embodiment, the control circuit is configured for determining the first and second duty cycle as a function of the input voltage, and the second duty cycle is zero for input voltages lower than a predefined threshold.

In an embodiment, the control circuit is configured for using said dynamic switching frequency, and the second duty cycle is zero for switching frequencies lower than a predefined frequency.

In an embodiment, the second duty cycle increases monotonically as a function of the input voltage, for input voltages larger than said threshold.

In an embodiment, the second duty cycle increases linearly as a function of the input voltage, for input voltages larger than said threshold.

In an embodiment, the second duty cycle increases monotonically as a function of the dynamic frequency, for frequencies larger than said predefined frequency.

In an embodiment, the second duty cycle increases linearly as a function of the dynamic frequency, for frequencies larger than said predefined frequency.

In an embodiment, the power converter further comprises a first rectifier circuit at an input of the full bridge, configured for receiving an AC voltage, and configured for providing a rectified voltage as said input voltage to the full bridge.

In an embodiment, the first rectifier circuit is configured for receiving an AC voltage in the range from about 108 Vac to about 305 Vac at a frequency in the range from about 50 Hz to about 60 Hz.

In an embodiment, the power converter further comprises a secondary inductance magnetically coupled to the first inductance.

In an embodiment, the power converter further comprises a second rectifier circuit connected to said secondary inductance, and configured for providing a DC output voltage.

In an embodiment, the output voltage is a voltage in the range from about 50 V to about 100 V.

According to a second aspect, the present invention also provides a lighting device comprising: a light source comprising at least one Light Emitting Diode; and a power converter according to the first aspect, configured for powering said light source.

The present invention is also directed to the use of a power converter according to the first aspect, for power factor correction.

These and other aspects of the inventions will be apparent from and elucidated with reference to the embodiment(s) described hereinafter.

### BRIEF DESCRIPTION OF THE DRAWINGS

FIG. 1(a) shows a high-level block-diagram of an electrical system comprising an AC power source, a rectifier circuit, a power converter circuit, and an electric load.

FIG. 1(b) shows an exemplary rectifier circuit, known in the art.

FIG. 2(a) shows a block-diagram of a classical full-bridge inverter circuit.

FIG. 2(b) shows a table with two complementary energizing states, which is typically used for controlling the switches of the full bridge of FIG. 2(a).

FIG. 2(c) shows the table of FIG. 2(b) and shows how the switches may be configured during two “off-periods” (or “dead zones” or “dead time”) between the energizing states. These zones are typically generated by asynchronous logic, and are not considered to be states.

FIG. 3 shows a power converter circuit comprising a full bridge inverter, and a resonant LLC circuit, proposed by the present invention.

FIG. 4 shows a table with two complementary energizing states, and two passive conducting states, proposed by the present invention, for controlling the full bridge inverter of FIG. 3.

FIG. 5 shows exemplary waveforms of the control signals applied to the switches, corresponding to the table of FIG. 4, as well a waveform of the voltage “Vx−Vy” generated by the power converter of FIG. 3.

FIG. 6(a) and FIG. 6(b) show exemplary waveforms of inductor current through, and voltage over the resonant circuit of FIG. 3, when using a symmetric bridge having four identical switches, and when applying the four phases shown in FIG. 4, for a heavy load (FIG. 6a), and for a small load (FIG. 6b).

FIG. 7 shows an example of a possible relationship between the “phase” or “duty cycle of the passive conducting phases (φ2, φ4) as a function of input voltage, as can be used in embodiments of the present invention.

FIG. 8(a) and FIG. 8(b) show exemplary waveforms of inductor current through, and voltage over the resonant circuit of FIG. 3, when using an asymmetric bridge having different types of switches for the first and second leg, and when using the four phases of FIG. 4, and when using a suitable duty cycle, for a heavy load (FIG. 8a) and for a small load (FIG. 8b).

FIG. 9 show exemplary waveforms of inductor current through and voltage over the resonant circuit of FIG. 3, in an asymmetric bridge, but driven with an incorrect sequence.

The drawings are only schematic and are non-limiting. In the drawings, the size of some of the elements may be exaggerated and not drawn on scale for illustrative purposes.

### DETAILED DESCRIPTION

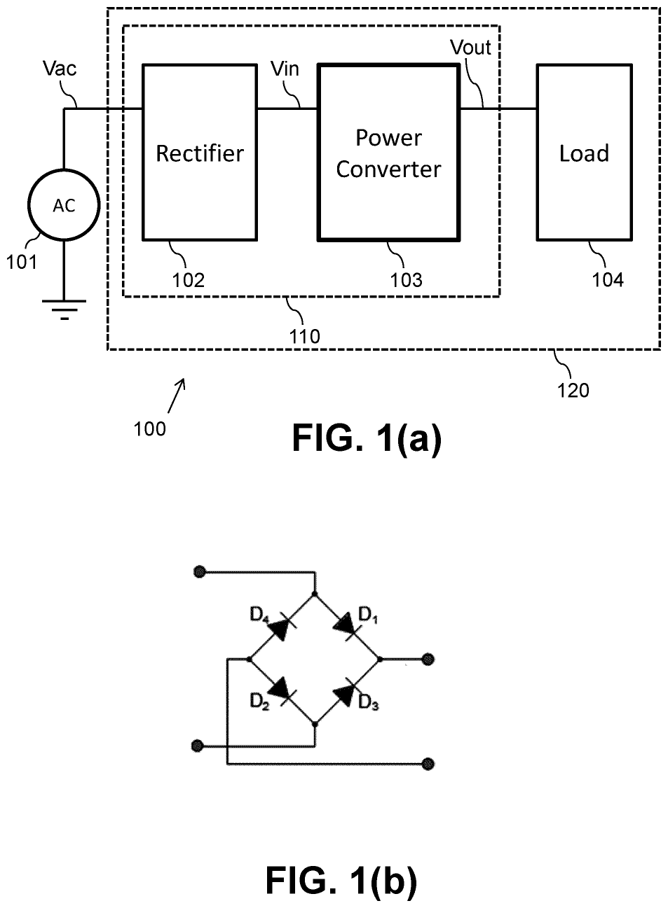

In this document, the notations FIG. 1(a) and Fig. la mean the same. Of course, this does not only apply for FIG. 1(a) but also for other Figures.

In this document, the term “state” and “phase” means the same.

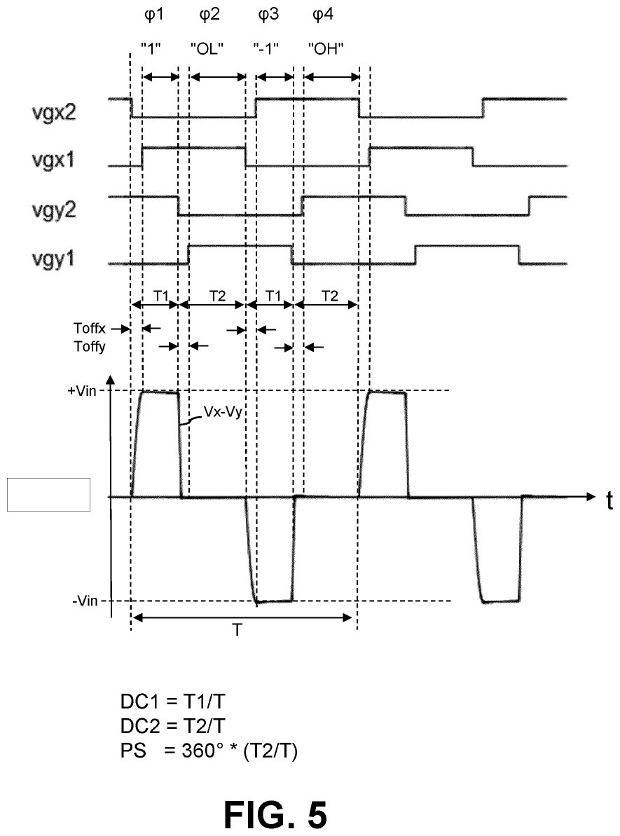

In this document, the expression “three-level operation” and “four phase operation” in principle mean the same (illustrated in FIG. 5); the “three levels” refer to the three possible voltages between the switching nodes; the “four phases” refer to the four possible states of the switches.

The present invention relates to power converter circuits.

FIG. 1(a) shows a high-level block-diagram of an electrical system 100 comprising an AC voltage source 101, a rectifier circuit 102, a power converter circuit 103, and an electric load 104.

The AC voltage source 101 may be configured for generating an alternating voltage Vac, e.g. a mains supply voltage of 220V at 50 Hz, or a mains supply voltage of 110V and 60 Hz, etc.

The rectifier circuit 102 is configured for converting the AC-voltage into a DC-voltage. Rectifier circuits are known in the art, and hence need not be described in full detail herein. For completeness, however, an example of a rectifier circuit is shown in FIG. 1(b), but other rectifier circuits may also be used.

The power converter circuit 103 is, or comprises a DC-DC converter circuit. It is configured for converting the DC input voltage “Vin” into a DC output voltage “Vout”, which is supplied to an electrical load 104.

The combination of the power converter 103 and the rectifier 102 is thus an AC-DC converter.

In general, the electrical load 104 can e.g. be a purely resistive load, or an inductive load, or a capacitive load. Heating devices and traditional incandescent lights are typical examples of resistive loads. Motors, compressors, speakers, etc. are typical examples of inductive loads. Capacitors and capacitor banks are typical examples of capacitive loads. In practice, many loads have an electrical impedance which is not purely resistive. The present invention, however, aims at providing power to electrical loads which are mainly of the resistive type, or of the constant power type, or of the constant voltage type, or of the constant current type, or combinations hereof.

In some embodiments, the present invention provides a power converter circuit 103 which is capable of converting power from a relatively large input voltage range to a narrow predefined output voltage range.

The present invention provides a particular power converter circuit 103, which is capable of converting power from a rectified AC voltage (the AC voltage having a nominal voltage from about 108 Vac to about 305 Vac and a frequency of about 50 Hz or about 60 Hz) to a predefined output voltage. The output voltage can be a regulated or controlled value having a predefined set point, for example chosen in the range from about 50V to about 100V, e.g. equal to about 75V, but the present invention is not limited thereto, and other set points can also be chosen.

The present invention also provides a particular power converter circuit 110 capable of converting power from an AC voltage source having a relatively large voltage range (e.g. from about 108 Vac to about 305 Vac) to said output voltage Vout, for powering said load.

The present invention also provides a power converter circuit capable of converting power from a relatively narrow input voltage range (e.g. from 220V±5% at about 50 Hz) to a predefined voltage in the relatively wide output range (e.g. from about 50 V to about 100 V).

The present invention also provides a lighting device 120 comprising one or more lighting elements 104 (e.g. one or more LED devices), and a power converter 103 or 110, with or without a rectifier 102 at its input. These lighting devices may be powered directly from the output voltage “Vout”, or indirectly, e.g. via a second dc-dc converter (not shown) connected to the output “Vout” of the converter 103.

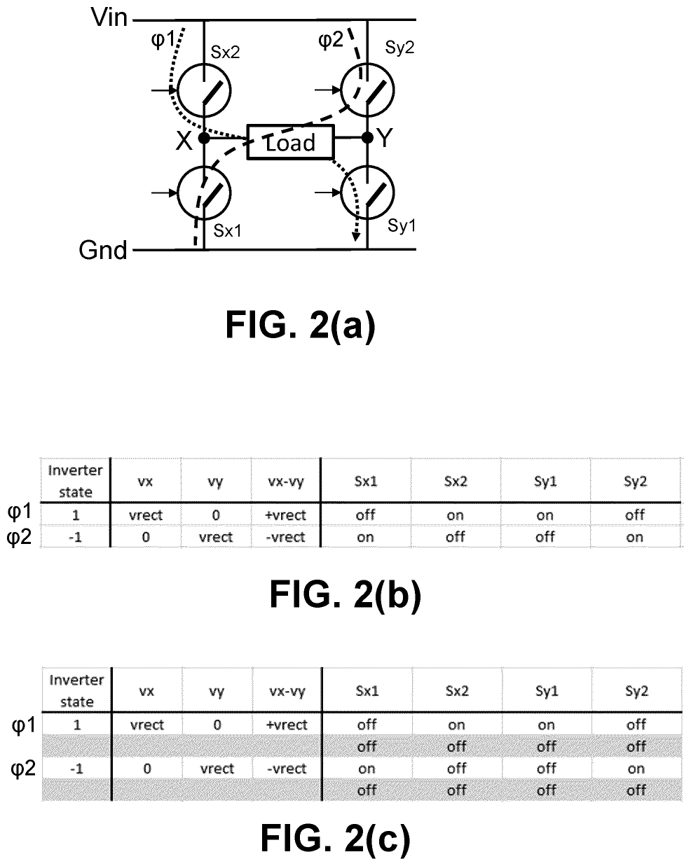

Before describing the solution proposed by the present invention in more detail, a classical full bridge circuit and a typical control thereof, is described with reference to FIG. 2(a) to FIG. 2(c).

FIG. 2(a) shows a block-diagram of a classical full-bridge inverter circuit, comprising four identical switches, e.g. in the form of transistors having a control gate for selectively opening and closing the respective switches. The switches Sx1 and Sy1 are called “low-side” switches. The switches Sx2 and Sy2 are called “high-side” switches. The switches Sx1 and Sx2 form a “first branch” or leg, and the switches Sy1 and Sy2 form a “second branch” or leg. The switches Sx1 and Sx2 define a switching node X between them. The switches Sy1 and Sy2 define a switching node Y between them. An electric load is connected between the nodes X and Y. The control signals applied to the control ports are typically generated by a control circuit (not shown), e.g. by a microcontroller, e.g. using pulse-width modulated (PWM)-signals.

FIG. 2(b) shows a table with two complementary energizing states φ1 and φ2, also referred to herein as “1” and “−1”, but this is merely a notation. In the first energizing phase (or state) φ1 the switches Sx2 and Sy1 are closed, and the other switches are open, thus X is connected to the supply voltage Vin, and Y is connected to ground, hence a voltage “+Vin” is applied to the load. In the second energizing phase (or state) φ2 the switches Sx1 and Sy2 are closed, and the other switches are open, thus Y is connected to the supply voltage Vin, and X is connected to ground, hence a voltage “−Vin” is applied to the load. The duty cycle of each phase is typically equal to 50%.

In practice, however, the switches will not open and close instantaneously, but this takes a certain amount of time. In order to avoid that both switches of one leg are closed at the same time, which would cause a short circuit between the supply voltage and ground, both switches Sx1 and Sx2 may deliberately be opened for a short period of time. Likewise, the switches Sy1 and Sy2 are typically both deliberately opened for a short period of time. This short period of time can be implemented as “another state” in the controller, or can be implemented outside of the controller, in an analog, asynchronous circuit, typically containing a delay line (e.g. formed by a series of inverters) and an “xor” gate. Such analog circuits are known in the art, and hence need not be explained in more detail here. The control signals which are provided to the control ports of the switches are illustrated in FIG. 2(c). The duration of this “dead time” is not important for the present invention, and will therefore not be further discussed.

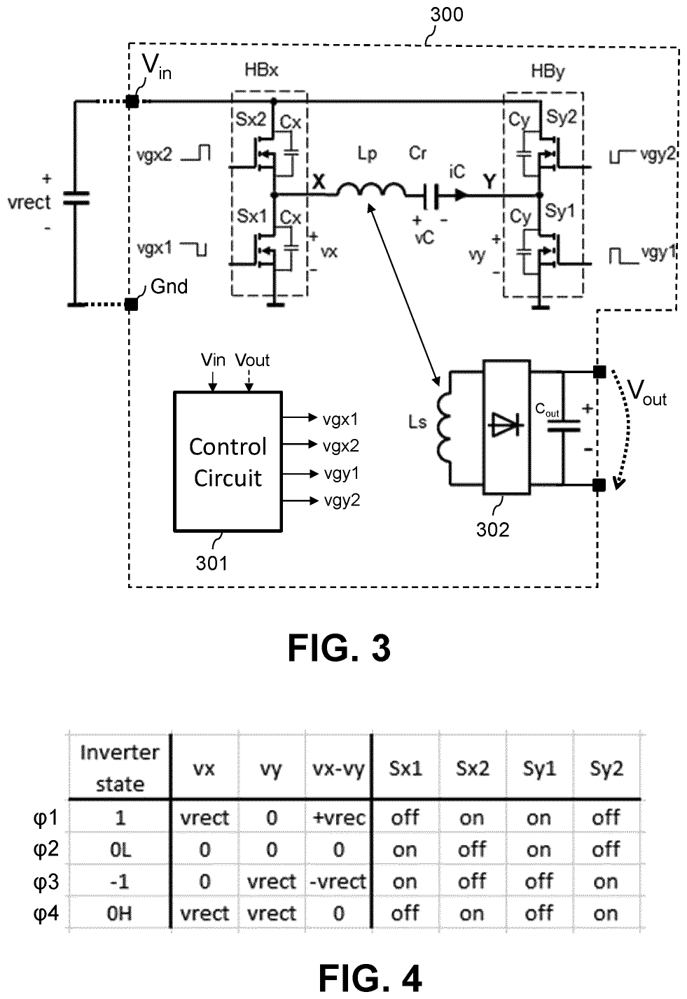

FIG. 3 shows a power converter circuit 300 comprising a full bridge inverter, and a resonant LLC circuit.

The full bridge contains two half bridges HBx and HBy, also referred to as “first and second leg”. The first half bridge HBx contains a first high-side switch Sx2 and a first low-side switch Sx1 connected in series between a supply node “Vin” and a ground node “Gnd”, and defining a first switch node X between them. The second half bridge HBy contains a second high-side switch Sy2 and a second low-side switch Sy1 connected in series between the supply node Vin and the ground node Gnd, and defining a second switch node Y between them.

The resonance circuit comprises a primary inductance Lp connected in series with a capacitance Cr. The resonance circuit is connected between said first switching node X and said second switching node Y. The primary inductance Lp is magnetically coupled to a secondary inductance Ls, for example as part of a transformer. The secondary inductance Ls may be connected to a second rectifier 302 and an output capacitor Cout, for providing an output voltage Vout, which is galvanically decoupled from the input voltage Vin, and which has a predefined voltage level (e.g. the above mentioned controlled voltage having a set point of about 75V).

The no-load resonance frequency of the LLC circuit can for example be in the order of about 100 kHz. During operation, the converter is typically operated in a frequency range from about 100 kHz to about 250 kHz, but the present invention is not limited thereto, and frequencies lower than 100 kHz or higher than 250 kHz are also possible.

The power converter circuit 300 further comprises a control circuit 301. The control circuit 301 may be configured for measuring one or both of said input voltage “Vin” in known manners (e.g. using a voltage divider and an analog-to-digital converter or ADC), and/or for measuring the output voltage Vout. In some embodiments only Vin is measured. In some embodiments only Vout is measured. In some embodiments both Vin and Vout are measured.

The control circuit 301 is configured for generating a set of control signals vgx2, vgx1, vgy2, vgy1 for selectively opening and closing the switches in accordance with a predefined scheme, proposed by the present invention, and for providing these control signals to said switches. This scheme, and its effect on the circuit of FIG. 3 will be described further.

The frequency at which the switches are opened and closed, is referred to as the “switching frequency”. In some embodiments, the switching frequency is fixed. In other embodiments, the switching frequency may vary dynamically. The dynamic switching frequency may be determined as a function of the input voltage, or as a function of the output voltage, or as a function of both the input voltage and the output voltage.

For ease of explanation, the present invention will be mainly explained assuming that the switching frequency is a predetermined (fixed) value, and the input voltage is measured, but the present invention is not limited hereto.

FIG. 4 shows a table, similar to that of FIG. 2(b), but having four states (or phases). As can be seen, this table also has two energizing states “1” and “−1” (referred to herein as phase φ1 and φ3), but the inventors came to the idea of adding also two passive conducting states, denoted herein as “0L” and “0H”, but also referred to as phase φ2 and φ4.

As mentioned above, the control circuit 301 is preferably also configured for providing an “off-period” or “dead time” between state-transitions, in order to avoid that the high-side switch and the low-side switch of the legs are accidentally closed simultaneously, which may be implemented as states or in an analog circuit, but this “dead time” is not further discussed.

It can be appreciated from the table of FIG. 4 and the block-diagram of FIG. 3, that, in case all states are used:
during the first energizing phase φ1 (also referred to as “1”), the first high-side switch Sx2 and the second low-side switch Sy1 are closed, and the other switches Sx1 and Sy2 are open, thereby connecting the first switching node X to Vin, and the second switching node Y to Gnd, and thus applying a voltage Vx−Vy=“+Vin” to the resonant LLC circuit;
during the second energizing phase φ3 (also referred to as “−1”), the second high-side switch Sy2 and the first low-side switch Sx1 are closed, and the other switches Sy1 and Sx2 are open, thereby connecting the second switching node Y to Vin, and the first switching node X to Gnd, and thus applying a voltage Vx−Vy=“−Vin” to the resonant LLC circuit;
during the first passive conducting phase φ2 (also referred to as “0L”), the two low-side switches Sx1 and Sy1 are closed, and the two high-side Sx2 and Sy2 are open, thereby connecting both switch nodes X, Y to Gnd, and thus applying a voltage Vx−Vy=“0” to the resonant LLC circuit;
during the second passive conducting phase φ4 (also referred to as “0H”), the two low-side switches Sx1 and Sy1 are open, and the two high-side switches Sx2 and Sy2 are closed, thereby connecting both switching nodes X, Y to the supply voltage “Vin”, and thus applying a voltage Vx−Vy=“0” to the resonant LLC circuit.

Thus, during the energizing phases φ1, φ3 either the supply voltage (+Vin) or the inverse supply voltage (−Vin) is applied to the resonance LLC circuit, for providing energy to the LLC circuit. The energizing phases may therefore also be referred to as “active conducting phases”. During the passive conducting phases φ2, φ4, no voltage difference is applied to the resonance LLC circuit, hence no energy is provided to the LLC circuit.

However, not all states have to be used under all circumstances, and they need not be applied in the specific order suggested in FIG. 4. In embodiments of the present invention, the control circuit may apply one of the following sequences or “schemes” during a particular switching period:

a) “1/−1”

b) “1/0L/−1/0H”

c) “1/0H/−1/0L”

d) “1/0L/−1/0L”

e) “1/0H/−1/0H”

For completeness, it is noted that the sequence “−1/+1” is considered equivalent to a), if applied repeatedly, and the sequences “0L/−1/0H/1” and “−1/0H/”1/0L″ and “0H/1/0L/−1/0H” are considered equivalent to b), etc.

FIG. 5 shows exemplary waveforms of the control signals vgx2, vgx1, vgy2, vgy1, to be applied to the corresponding switches Sx2, Sx1, Sy2, Sy1, for the switching sequence “1/0L/−1/0H”. The graph of FIG. 5 also shows an exemplary (close to ideal) waveform of the voltage difference “Vx−Vy” over the switching nodes X, Y.

Unfortunately, this close-to-ideal waveform of Vx−Vy is not automatically obtained, as will be explained further. The inventors were thus faced with additional problems.

In what follows, the terms “(one) switching period” corresponds to a cycle having a duration “T”. It consists of two “half cycles”, one for generating a positive pulse of Vx−Vy and one for generating a negative pulse of Vx−Vy. In principle, it does not matter which pulse comes first, as long as they alternate during one period, and as long as the same order is maintained over different periods.

In the specific example of FIG. 5, the first half cycle contains a first energizing phase φ1 and a first passive conductive phase φ2. The second half cycle contains a second energizing phase φ3 and a second passive conductive phase φ4. As can be seen, in practice, there is also a short “off-period” or “dead-time” between each energizing phase and passive conductive phase, but as already mentioned above, these are not the main focus of the present invention. Alternatively, the “dead time” can also be regarded as a (minor) portion of the duration of the respective phase. According to this convention, the period T1 is the time from the falling edge of vgx2 to the falling edge of vgy2, T2 is the time from the falling edge of vgy2 to the falling edge of vgx1, etc.

Important for the present invention is the relative duration T1/T, also referred to as the first duty cycle DC1, and the relative duration T2/T, also referred to herein as the second duty cycle DC2. This can be expressed mathematically as follows:

DC1=T1/T [1]

DC2=T2/T [2]

and the period duration T can be written as the sum of the durations of the two energizing phases and the two passive conducting phases:

T=(2*T1+2*T2) [3]

The relative duration of a third level (“0”) with respect to the total switching period T is referred to herein as the “phase shifting angle” PS, and can be expressed as an angle. This can be written mathematically as:

PS=360°*(T2/T) [4]

The phase shift angle PS is preferably smaller than 90°. The larger the phase shifting angle PS, the lower is the effective inverter's output voltage Vout for a given inverter input voltage Vin.

The inventors started experimenting, based on the switching sequence of FIG. 5 and the circuit of FIG. 3, not knowing what to expect.

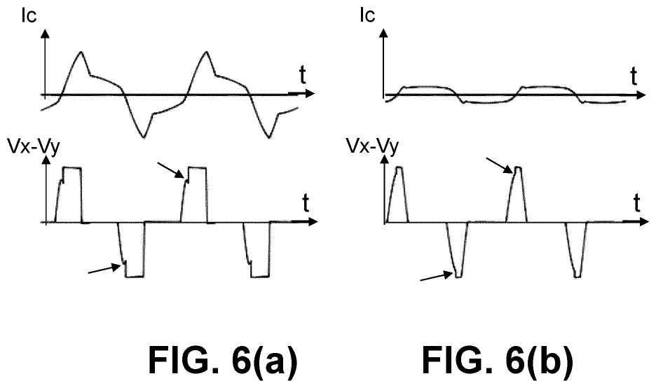

FIG. 6(a) and FIG. 6(b) show exemplary waveforms of inductor current through, and voltage over the resonant circuit of FIG. 3, when using the switching sequence “1/0L/−1/0H” for a heavy load (FIG. 6a) and a small load (FIG. 6b). In this simulation, the bridge contains four identical switches (output capacitance Cx=output capacitance Cy). Or stated in other words, FIG. 6(a) and FIG. 6(b) show simulation results for a symmetric bridge configuration (i.e. having four identical switches), when applying the “three-level operation mode” for an inverter input voltage Vrect=440 Vdc and for a high load (FIG. 6a), and a small load (FIG. 6b), being 10% of the high load.

As can be seen, there is a “hick-up” on the rising edges of the Vx−Vy waveform, but not on the falling edges. These experiments have shown that the driving scheme “1/0L/−1/0H” results in zero-voltage-switching (ZVS) for the first inverter leg HBx, but not for the second leg HBy, which shows undesired hard switching. Likewise, the driving scheme “1/0H/−1/0L” would result in zero-voltage-switching (ZVS) of the second leg HBy, but not for the first leg HBx, which would show hard switching. Thus, the inventors found that zero-voltage-switching (ZVS) condition was not achieved, not in the high load case (100%), or in the small load case (10%), but instead, the power converter circuit experiences extra losses (switching losses) and high frequency common mode EMI noise, both of which are undesirable.

The inventors came to the idea of using an asymmetric bridge, by using different types or size of switches for the first and second leg. What is important is that the output capacitance Cx of the switches of the first leg is different from the output capacitance Cy of the switches of the second leg. The effective capacitance typically depends on the transistor technology (e.g. silicon super-junction or GaN enhancement mode HEMT) and on the die area.

They decided to use switches Sx1 and Sx2 of a first type, having a first output capacitance Cx, and to use switches Sy1 and Sy2 of a second type, having a second output capacitance Cy different from Cx. For ease of the description, it is assumed that the second output capacitance Cy is smaller than the first output capacitance Cx, unless explicitly mentioned otherwise (e.g. FIG. 9).

Preferably a ratio of Cy and Cx is a value in the range from ¼ to ¾ (i.e. from about 0.25 to about 0.75), or from ⅓ to ⅔ (thus from about 0.33 to about 0.66), for example equal to about ½ (i.e. equal to about 0.5).

The inventers further found that not just any duty cycle will yield good results. In fact, the “three-level operation” can lead to a loss of zero voltage switching (ZVS) already at moderate phase shift angles (values of DC2), which would lead to unacceptable losses and common mode interferences. Further experiments showed that, when applying a phase shift PS (or a value of DC2) that increases with the input voltage Vin, these losses can be reduced.

More particularly, the inventors found that:
in order to best exploit the power train of the LLC in a PFC application the full bridge would operate with a 2-level driving scheme at low instantaneous input voltages and with a 3-level scheme at values of vrect above a threshold.
the relative duration of the zero-state “0” can vary from 0° to 90° (assuming 360° corresponds to the full switching period T). The PFC operation of the LLC results in a switching frequency characteristic that tends to be proportional to the instantaneous mains voltage (Vrect). Phase-shifting operation provides a second manipulating variable to control the converter i.e., the phase shift angle in addition to e.g. the switching frequency (that can be controlled either explicitly or implicitly).
the phase shift angle can be controlled in a feed-forward manner.

Based on these insights, the present invention proposes a power converter 300 comprising an asymmetric bridge, and an LLC resonant circuit, and a controller 301, wherein the controller is adapted for measuring the input voltage Vin (and optionally also the output voltage Vout), and for applying a scheme having only “two-levels” (e.g. scheme “1/−1”, corresponding to the phases φ1, φ3) in case the input voltage Vin is smaller than a predefined voltage Vth, and for applying the above described “three-level operation” (e.g. scheme “1/0L/−1/0H” or scheme “1/0H/−1/0L”, corresponding to the phases φ1, φ2, φ3, φ4 or φ1, φ4, φ3, φ2) in case the input voltage is higher than said predefined voltage Vth.

Thus, in preferred embodiments of the present invention, the control circuit 301 measures the input voltage Vin, and
if the measured input voltage Vin is smaller than a predefined threshold voltage Vth, the control circuit 301 applies a two-level driving scheme (e.g. the sequence “1/−1”), wherein each of the energizing phases φ1, φ3 has a duty cycle of about 50%;
if the measured input voltage Vin is higher than the predefined voltage level Vth, the control circuit 301 applies one of the above mentioned three-level driving schemes (“1/0L/−1/0H” or “1/0H/−1/0L”).

In preferred embodiments, the second duty cycle DC2 (also referred to herein as “phase shift”) monotonically increases with the amplitude of the input voltage Vin. In a digital circuit, this can be implemented e.g. according to a polynomial function, e.g. a first order polynomial, or a second order polynomial, or a third order polynomial having predefined coefficients, or using a piece-wise-linear approximation (not shown). These curves or coefficients may be hardcoded, or may be stored in a non-volatile memory of the control circuit. But the desired feed-forward function can also be implemented by an analog circuit.

Alternatively, instead of making the phase shifting angle PS dependent on the input voltage “Vin”, the phase shifting angle PS can be varied as a function of the switching frequency, which would have a similar result. But other control configurations, wherein the phase shift is increased for increasing input voltages “Vin” will also work.

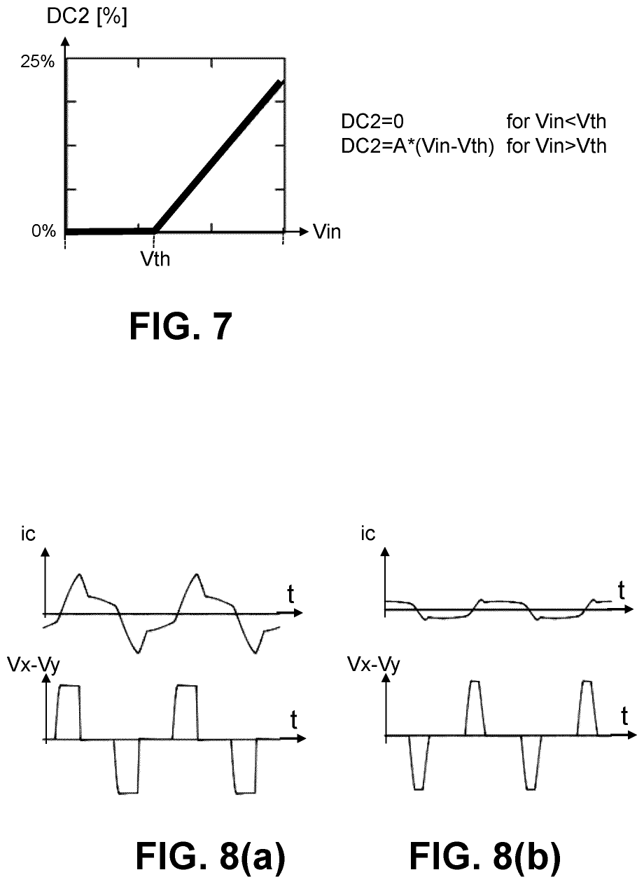

In a particular embodiment, the second duty cycle DC2, or “phase shift” linearly increases with the input voltage Vin, for voltages larger than the threshold level Vth, as illustrated in FIG. 7. This can be expressed mathematically as:

DC2=0, if Vin<Vth [4]

DC2=A*(Vin−Vth), if Vin>Vth [5]

where Vth is a predefined voltage level, and A is a predefined constant. The value of Vth and A can be determined during design, or by simulation, and may be stored in a non-volatile memory of the control circuit 301 (e.g. in EEPROM or flash memory), or by an analog circuit (not shown).

It is an advantage of operating the asymmetric full bridge selectively using the “phase shifting mode” and the “three-level mode” depending on the input voltage Vin, that it enables zero-voltage switching operation, thus power conversion with reduced switching losses and reduced emi-interference.

It is a further advantage because it allows that the resonant tank elements (e.g. the inductance Lp and the capacitance Cr) can be designed for a lower total voltage swing resulting in smaller components or less power losses, since less reactive current is needed.

In another embodiment (not shown), the switching frequency is dynamically updated, for example based on the measured input voltage and output voltage, e.g. in a manner such that the output voltage level is substantially equal to a predefined value (e.g. equal to about 75V). In this case, the second duty cycle may be controlled as a function of the switching frequency, for example using a similar plot as shown in FIG. 7, but the horizontal axis would indicate frequency rather than input voltage. Thus, if the dynamic frequency is smaller than a predefined frequency value, the value of DC2 is set to zero, and if the dynamic frequency is larger than said predefined frequency value, the value of DC2 would monotonically, e.g. linearly increase with the dynamic frequency. This can be expressed mathematically as:

DC2=0, if fdyn<f0 [6]

DC2=A*(fdyn−f0), if fdyn>f0 [7]

where fdyn is the dynamically determined frequency, f0 is a predefined frequency, and A is a predefined constant. The value of f0 and A can be determined during design, or by simulation, and may be stored in a non-volatile memory of the control circuit 301 (e.g. in EEPROM or flash memory), or by an analog circuit (not shown). The same advantages as mentioned above can be obtained.

The dynamic frequency may be determined in known manners. For the sake of completeness, one such algorithm is briefly described next. The method of determining the dynamic frequency could start from a predefined frequency value, and repeatedly perform the following steps: (i) measure the output voltage, (ii) compare the output voltage with a set output value (e.g. a predefined value of 75V), and (iii) if the measured output voltage is higher than the set value, increase the dynamic frequency with a predefined amount or with a predefined factor; and if the measured output voltage is lower than the set value, decrease the dynamic frequency with a predefined amount or with a predefined factor. Of course, many variants of this basic algorithm are possible.

In what follows, it is assumed again that the switching frequency is fixed, and that the duty cycles are determined as shown in FIG. 7.

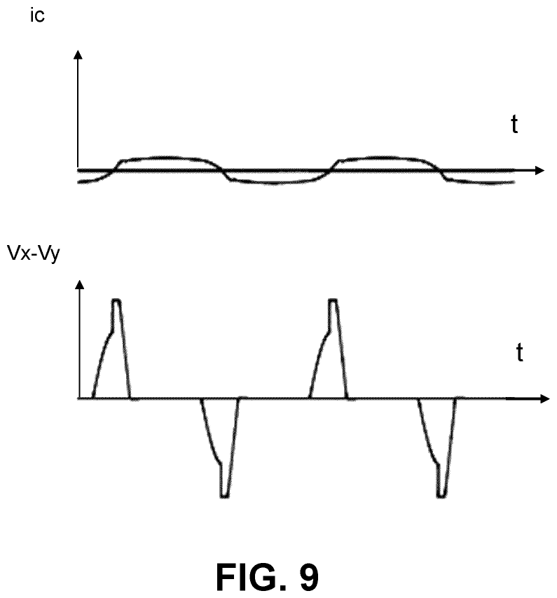

FIG. 8(a) and FIG. 8(b) show exemplary waveforms of inductor current through, and voltage over the resonant circuit of FIG. 3, when using the switching sequence “1/0L/−1/0H” for a heavy load (FIG. 8a) and a small load (FIG. 8b). In this simulation, the bridge is asymmetric, with Cy=Cx/2. As can be seen, also in this case there is no, or no significant hick-up in the rising or falling edges of the voltage waveform, hence both inverter legs show zero-voltage switching (ZVS). The switching losses are reduced, thus the power efficiency improved. There is less ringing, hence, less emi-disturbance.

It was found that, if the switches are driven in a way such that the first commutation takes place at the inverter leg with the large switch node capacitance, zero-voltage switching (ZVS) is enabled over an extended phase shifting angle without compromising Rdson-losses.

FIG. 9 show what happens if the driving scheme “1/0L/−1/0H” is applied to an asymmetric full bridge inverter wherein the switches of the leg HBy has a higher capacitance than the switches of the leg HBx. In the example of FIG. 9, Cx=Cy/2, and the load is the same as the small load of FIG. 8(b). As can be seen, in this case, the inverter commutates into the zero-state by switching the leg HBx with the small transistors first, resulting in a pronounced hard switching of the half-bridge HBy.

While not explicitly shown, if the other driving scheme “1/0H/−1/0L” would be applied for this asymmetric bridge, the same results as shown in FIG. 8(b) would be obtained, thus zero-voltage-switching (ZVS) would be achieved.

Based on the above, the skilled person can easily find a suitable set of switches, e.g. by simulations or by trial and error. In general, as to the selection of switching devices a lower Rdson is desired which however, comes with an increasing die size and thus capacitances (and costs). The output capacitance (Coss) on the other hand should be low enough to enable ZVS under all operation conditions. The switches may for example be MOSFET switches, or GaN transistors, but the present invention is not limited thereto.

While the present invention is explained for a resonant converter of the LLC type, the principles of the present invention can also be applied to other resonant converters, such as LCC.

While the present invention is explained mainly for a phase shifting angle PS which varies as a function of the input voltage “Vin”, it is also possible to vary the phase shifting angle PS with the switching frequency. After all, as a result of the PFC (power factor conversion) operation of the LLC converter, its switching frequency increases with the input voltage (vrect). In other words, any of the input voltage “Vin” and the switching frequency can be used to govern the phase shifting angle PS.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope thereof.

1. A power converter for converting an input voltage (Vin) into an output voltage (Vout), the power converter comprising:
a full bridge inverter comprising a first leg (HBx) and a second leg (HBy),
the first leg (HBx) comprising a first high-side switch (Sx2) and a first low-side switch (Sx1) connected in series, and defining a first switch node (X) between them;
the second leg (HBy) comprising a second high-side switch (Sy2) and a second low-side switch (Sy1) connected in series, and defining a second switch node (Y) between them;
wherein the switches (Sx1, Sx2) of the first leg (HBx) have a first output capacitance (Cx), and the switches (Sy1, Sy2) of the second leg (HBy) have a second output capacitance (Cy);
a resonance circuit connected between said first switch node (X) and said second switch node (Y), and comprising an inductance (Lp) and a capacitance (Cr) coupled in series with the inductance (Lp);
a control circuit configured for generating a set of control signals (vgx2, vgx1, vgy2, vgy1) in accordance with a predefined scheme, and for providing these control signals to said switches;
wherein the predefined scheme comprises two energizing phases (ϕ1, ϕ3) wherein the input voltage (Vin) is alternatingly applied over the first and second switch node (X, Y);
characterized in that
the second output capacitance (Cy) is smaller than the first output capacitance (Cx);
the predefined scheme furthermore comprises two passive conducting phases (ϕ2, ϕ4) interleaved with the two energizing phases (ϕ1, ϕ3);
the control signals (vgx2, vgx1, vgy2, vgy1) in the passive conducting phases being chosen for facilitating zero-voltage-switching condition of the switches (Sx1, Sx2) of the first leg (HBx) during at least some phase transitions.

2. A power converter according to claim 1, wherein the switches are MOSFETs or GaN HEMTs.

3. A power converter according to claim 1,
wherein a ratio of the second output capacitance (Cy) and the first output capacitance (Cx) is a value in the range from ¼ to ¾, or from ⅓ to ⅔.

4. A power converter according to claim 3, wherein a ratio of the second output capacitance (Cy) and the first output capacitance (Cx) is equal to about 0.5.

5. A power converter according to claim 1,
wherein the control circuit is further configured for measuring one or both of the input voltage (Vin) and the output voltage (Vout);
and wherein the control circuit is further configured for using a predefined switching frequency or for using a dynamic switching frequency, wherein the dynamic switching frequency is based on one or both of the measured input voltage (Vin) and the measured output voltage (Vout);
and wherein the switches (Sx1, Sx2) of the first leg (HBx) and the switches (Sy1, Sy2) of the second leg (HBy) are switched at the predefined or the dynamic switching frequency (f).

6. A power converter according to claim 5,
wherein each of the energizing phases (ϕ1, ϕ3) has a first duty cycle (DC1);
and wherein each of the passive conducting phases (ϕ2, ϕ4) has a second duty cycle (DC2);
and wherein the control circuit is further configured for determining the first and the second duty cycle (DC1, DC2) as a function of one or more of the input voltage (Vin), the output voltage (Vout), and the switching frequency (f).

7. A power converter according to claim 6,
wherein the control circuit is configured for determining the first and second duty cycle (DC1, DC2) as a function of the input voltage (Vin), and wherein the second duty cycle (DC2) is zero for input voltages (Vin) lower than a predefined threshold (Vth); or converter
wherein the control circuit is configured for using said dynamic switching frequency, and wherein the second duty cycle (DC2) is zero for switching frequencies (f) lower than a predefined frequency.

8. A power converter according to claim 5, wherein the second duty cycle (DC2) increases monotonically, or increases linearly as a function of the input voltage (Vin), for input voltages larger than said threshold (Vth).

9. A power converter according to claim 5, wherein the second duty cycle (DC2) increases monotonically, or increases linearly as a function of the dynamic frequency, for frequencies larger than said predefined frequency.

10. A power converter according to claim 1,
further comprising a first rectifier circuit at an input of the full bridge, configured for receiving an AC voltage, and configured for providing said input voltage (Vin) to the full bridge.

11. A power converter according to claim 10, wherein the first rectifier circuit is configured for receiving an AC voltage in the range from about 108 Vac to about 305 Vac at a frequency in the range from about 50 Hz to about 60 Hz.

12. A power converter according to claim 1,
further comprising a secondary inductance (Ls) magnetically coupled to the first inductance (Lp).

13. A power converter according to claim 12, further comprising a second rectifier circuit connected to said secondary inductance (Ls), and configured for providing a DC output voltage (Vout).

14. A power converter according to claim 13, wherein the output voltage (Vout) is a voltage in the range from about 50 V to about 100 V.

15. A lighting device comprising:
a light source comprising at least one Light Emitting Diode;
a power converter according to claim 1, configured for powering said light source.
